(19) United States
(12) Patent Application Publication
(10) Pub. No.: US 2003/0070501 A1
(43) Pub. Date: Apr. 17, 2003

(54) Axle lubricant isolation

(76) Inventor: Dale K. Bell, Ortonville, MI (US)

Correspondence Address: CARLSON, GASKEY & OLDS, P.C., 400 WEST MAPLE ROAD, SUITE 350, BIRMINGHAM, MI, 48009, US

(21) Appl. No.: 09/981,238

(22) Filed: Oct. 17, 2001

(51) Int. Cl. F16H 57/04; F01M 9/00

(52) U.S. Cl. 74/424; 74/607; 184/6.12

(57) ABSTRACT

A drive axle assembly is provided that includes an axle housing that supports axle shafts. The axle housing also typically includes a bearing cage secured to the main axle housing portion for supporting a drive shaft that is arranged transverse to the axle shafts. A differential is arranged within the axle housing and couples the driven shafts to the axle shafts. A bearing assembly supports the driven shaft within the bearing cage. A seal is arranged between the driven shaft and the bearing cage, preferably between the cone and the bearing cage. The seal is adjacent to the bearing assembly and separates the axle housing into first and second cavities in which the bearing assembly is arranged in the first cavity and the differential is arranged in the second cavity. Lubricant containing a GL5 or similar additive may be placed in the second cavity to lubricate the differential. Another lubricant without the GL5 additive more suitable for bearings may be placed in the first cavity to lubricate the bearing assembly.

### BACKGROUND OF THE INVENTION

This invention relates to a drive axle assembly, and more particularly, the invention relates to a bearing cage seal.

Drive axles typically include a differential gear set to permit relative rotation between the axle shafts during vehicle turns. The differential receives rotational drive from a shaft having a pinion coupled to a ring gear connected to the differential. The shaft may include a yoke opposite the pinion that is connected to a drive or propeller shaft connected to the vehicle transmission. The shaft is typically supported by a bearing cage in heavy duty vehicle applications that is secured to the main portion of the axle housing. Through shafts in tandem axle arrangements are also typically supported by a bearing cage.

Heavy duty drive axles typically have lubricant with a GL5 additive to provide an adequate lubricating film to sufficiently lubricate the pinion, ring gear, and differential. This same lubricant with GL5 additive is also used to lubricate the bearings supporting the shaft in the bearing cage. While GL5 additive is desirable to lubricate the pinion, ring gear, and differential, it is corrosive to bearings and reduces the life of the bearing. Furthermore, a large amount of lubricant with the GL5 additive is needed to lubricate the bearing cage bearings, which is remotely located from the differential. As a result, the ring gear and differential must move through a greater volume of lubricant, which decreases the efficiency due to churning losses. Additionally, GL5 additive has been considered by some to pose an environmental hazard. Therefore, what is needed is a drive axle assembly that reduces the amount of lubricant with GL5 additive while extending the bearing cage bearing life and increasing the efficiency of the drive axle.

### SUMMARY OF THE INVENTION AND ADVANTAGES

The present invention provides a drive axle assembly including an axle housing that supports axle shafts. The axle housing also typically includes a bearing cage secured to the main axle housing portion for supporting a drive shaft that is arranged transverse to the axle shafts. A differential is arranged within the axle housing and couples the driven shafts to the axle shafts. A bearing assembly supports the driven shaft within the bearing cage. A seal is arranged between the driven shaft and the bearing cage, preferably between the cone and the bearing cage. The seal is adjacent to the bearing assembly and separates the axle housing into first and second cavities in which the bearing assembly is arranged in the first cavity and the differential is arranged in the second cavity. Lubricant containing a GL5 or similar additive may be placed in the second cavity to lubricate the differential. Another lubricant without the GL5 additive, which is more suitable for bearings, may be placed in the first cavity to lubricate the bearing assembly. In this manner, the GL5 additive is prevented from entering the first cavity and corroding the bearing assembly. Additionally, the volume of lubricant having a GL5 additive may be reduced since it need not lubricate the remotely located bearing assembly.

Accordingly, the above invention provides a drive axle assembly that reduces the amount of lubricant with GL5 additive while extending the bearing cage bearing life and increasing the efficiency of the drive axle.

### BRIEF DESCRIPTION OF THE DRAWINGS

Other advantages of the present invention can be understood by reference to the following detailed description when considered in connection with the accompanying drawings wherein:

FIG. 1 is a schematic view of a tandem axle system;

FIG. 2 is a partial cross-sectional view of a rear drive axle shown in FIG. 1; and

FIG. 3 is an enlarged cross-sectional view of the bearing cage and seal of the present invention.

### DETAILED DESCRIPTION OF THE PREFERRED EMBODIMENT

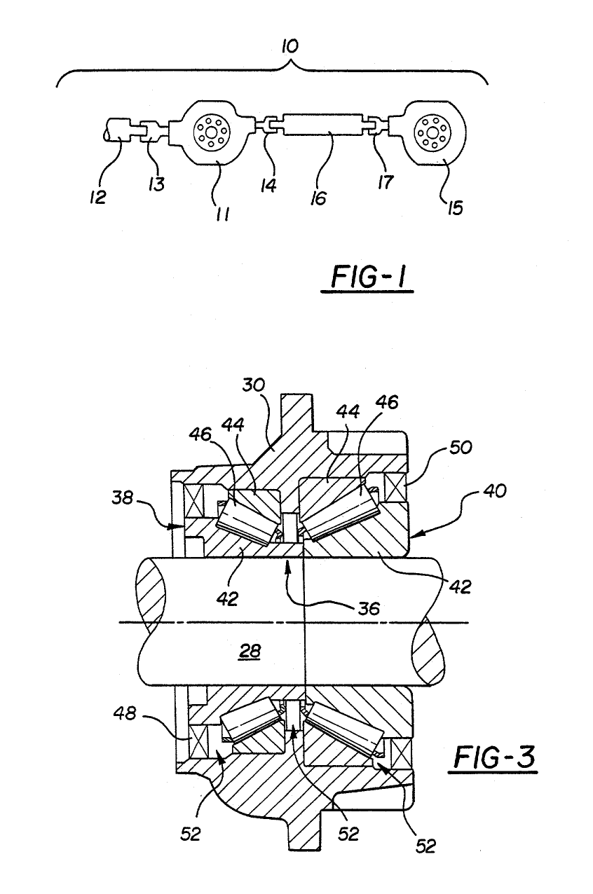

A tandem axle system 10 is schematically shown in FIG. 1. The tandem axle system 10 includes a front drive axle 11 having an input shaft 13 receiving rotational drive from a drive shaft 12 that is coupled to a transmission. The front drive axle 11 includes a through shaft 14 to transmit rotational drive from the front drive axle 11 to a rear drive axle 15. In this manner, both the front 11 and rear 15 drive axles receive rotational drive from the vehicle transmission. The rear drive axle 15 includes a pinion shaft 17 that receives rotational drive from a drive shaft 16 coupled to the through shaft 14 and pinion shaft 17. The input shaft 13, through shaft 14, and pinion shaft 17 are typically supported in the axle housing by a bearing cage having a bearing assembly supporting the shaft that is secured to the main portion of the axle housing to facilitate assembly of the drive axle.

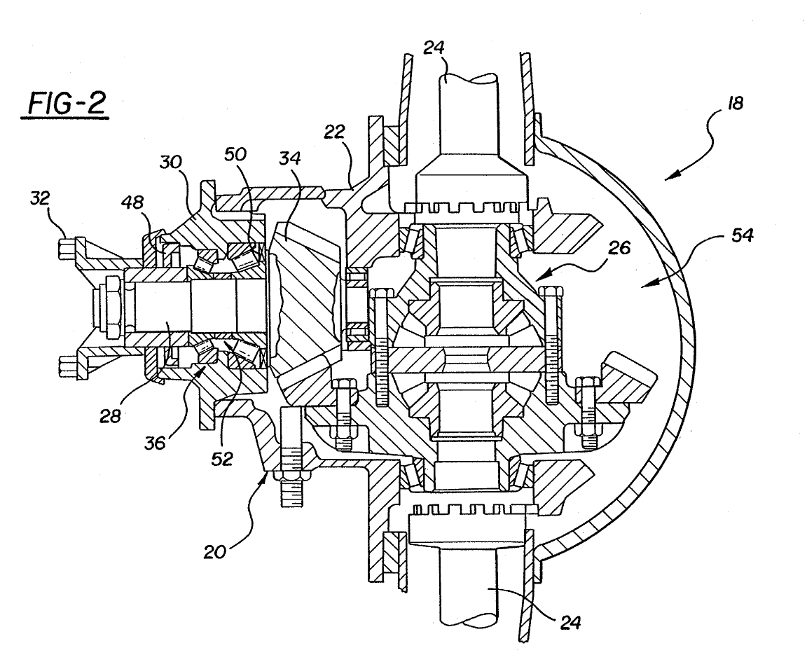

Referring to FIG. 2, a drive axle assembly 18 is shown which corresponds to the rear drive axle 15 in the tandem axle system 10 shown in FIG. 1. However, it is to be understood that while the present invention is discussed in terms of a rear drive axle 15 having a pinion shaft 17, the present invention may also be used for front drive axle arrangements in a tandem axle system for either the input shaft or through shaft. The drive axle assembly 18 includes an axle housing 20, which may include a main housing portion 22 and a bearing cage 30 secured in some arrangements, the bearing cage may be integral with the housing 22. This invention may be applied there as well. Co-axial axle shafts 24 are supported by the main housing portion 22 and are coupled by a differential 26 in a central portion of the housing 20 for relative rotation. A driven shaft 28 is supported within the bearing cage 30 by bearing assembly 36. The driven shaft 28 may refer to an input shaft 13, a through shaft 14, or a pinion shaft 17. The driven shaft 28, which is a pinion shaft as shown in FIG. 2, includes a yoke 32 at one end that is coupled to a drive shaft. A pinion 34 is arranged opposite the yoke 32 on the driven shaft 28 and is coupled to the differential 26. For a through shaft in a front drive axle, the driven shaft 28 may include a feature other than the pinion 34.

Referring to FIGS. 2 and 3, the bearing assembly 36 may include first 38 and second 40 tapered roller bearings. Each bearing includes a cone 42 secured to the driven shaft 28 and a cup 44 secured to the bearing cage 30. Rolling elements 46 are arranged between the cone 42 and cup 44. While a pair of tapered roller bearings are shown, other bearing arrangements may be used. For example, a unitized bearing assembly may be used to support the driven shaft 28 within the bearing cage 30. Unitized bearings typically include a single or common cup and a pair of cones that are secured to one another in a central region of the unitized bearing. Unitized bearings also typically include a seal between each cone and the cup at the outside of the unitized bearing to prevent ingress or egress of lubricant to and from the unitized bearing.

A seal 48 is typically arranged between the driven shaft 28 and the bearing 30 adjacent to the yoke 32 to prevent debris from entering the drive axle. The present invention incorporates another seal 50 between the driven shaft 28 and bearing cage 30 adjacent to the bearing assembly 36 opposite the seal 48. The seal 50 divides the axle housing 20 into first 52 and second 54 cavities. The first cavity 52 contains the bearing assembly 36, and the second cavity 54 contains the differential 26, ring gear, and pinion 34. In this manner, lubricant containing GL5 additive may be used in the second cavity 54 and prevented from entering the first cavity 52 where it may corrode the bearing assembly 36. Moreover, the amount of lubricant containing GL5 additive may be reduced thereby reducing the potential environmental hazard and churning losses within the drive axle, which may increase drive axle efficiency. A lubricant more suitable for use with bearings without a GL5 or similar additive may be used in the first cavity 52 to lubricate the bearing assembly 36.

The cone 40 may be extended to support the seal 50 between the cone 40 and the bearing cage 30. Any suitable seal 50 may be used, which may depend upon the particular application, such as whether the bearing cage is used with an input shaft, a through shaft, or a pinion shaft.

The invention has been described in an illustrative manner, and it is to be understood that the terminology that has been used is intended to be in the nature of words of description rather than of limitation. Obviously, many modifications and variations of the present invention are possible in light of the above teachings. It is, therefore, to be understood that within the scope of the appended claims the invention may be practiced otherwise than as specifically described.

What is claimed is:

1. A drive axle assembly comprising:
an axle housing;
an axle shaft supported at least partially within said axle housing;
a driven shaft supported at least partially within said housing transverse to said axle shafts;
a gear assembly disposed within said housing coupling said axle and driven shafts;
a bearing assembly supporting said driven shaft in said housing;
a seal interposed between said driven shaft and said housing adjacent to said bearing assembly separating said housing into first and second cavities with said bearing assembly and said gear assembly respectively disposed therein;
a first lubricant in said first cavity lubricating said bearing assembly; and
a second lubricant different than said first lubricant in said second cavity lubricating said gear assembly.

2. The drive axle assembly according to claim 1, wherein said axle housing includes a main housing portion supporting said axle shaft and a bearing cage secured to, or integral with, said main housing portion supporting said driven shaft.

3. The drive axle assembly according to claim 2, wherein said bearing cage is a pinion bearing cage.

4. The drive axle assembly according to claim 2, wherein said bearing cage is a through shaft bearing cage.

5. The drive axle assembly according to claim 2, wherein said bearing cage is an input bearing cage.

6. The drive axle assembly according to claim 2, wherein said seal is interposed between cage and said driven shaft.

7. The drive axle assembly according to claim 6, wherein said bearing assembly includes a cup affixed to said cage and a cone affixed to said shaft with rolling elements arranged between said cup and said cone, said seal interposed between said cage and said cone.

8. The drive axle assembly according to claim 1, wherein said second lubricant includes a GL5 additive.

9. The drive axle assembly according to claim 1, further including coaxial axle shafts, wherein said gear assembly includes a differential connecting said axle shafts and said driven shaft to permit relative rotation between said axle shafts.

10. The drive axle assembly according to claim 1, further including a second seal interposed between said driven shaft and said housing adjacent said bearing assembly opposite said seal.

11. A drive axle bearing cage assembly comprising:
a bearing cage;
a driven shaft supported by said bearing cage having a yoke at one end;
a bearing assembly supporting said driven shaft in said bearing cage between said yoke and said pinion;
a first seal interposed between said driven shaft and said bearing cage adjacent to said yoke;
a second seal interposed between said driven shaft and said bearing cage adjacent to said pinion.

12. The drive axle bearing cage assembly according to claim 11, wherein said seal is interposed between cage and said driven shaft.

13. The drive axle bearing cage assembly according to claim 12, wherein said bearing assembly includes a cup affixed to said cage and a cone affixed to said shaft with rolling elements arranged between said cup and said cone, said seal interposed between said cage and said cone.
